(19) United States
(12) Patent Application Publication
(10) Pub. No.: US 2011/0196588 A1
(43) Pub. Date: Aug. 11, 2011

(54) METHOD FOR ENGAGING A TORQUE CONVERTER LOCK-UP CLUTCH IN A POWER TRANSMISSION OF A MOBILE MACHINE

(75) Inventors: Hans Hofler, Immenstaad (DE); Thomas Kurz, Langenargen (DE)

(73) Assignee: ZF FRIEDRICHSHAFEN AG, Friedrichshafen (DE)

(21) Appl. No.: 13/124,842

(22) PCT Filed: Sep. 29, 2009
(86) PCT No.: PCT/EP2009/062591

§ 371 Date: Apr. 19, 2011

(30) Foreign Application Priority Data
Oct. 23, 2008 (DE) 10 2008 043 109.5

(51) Int. Cl. F16D 48/06; B60W 30/18; B60W 10/08; B60W 10/02

(52) U.S. Cl. 701/67

(57) ABSTRACT

A method of engaging a converter lock-up clutch in a power-shift transmission of a working machine. According to the method, the available engine torque or the turbine torque is determined, prior to an engagement of the converter lock-up clutch, and, depending on the determined engine torque or the determined turbine torque, the gradient of the engine torque is controlled by the transmission control unit during engagement and optionally controlled for a defined period of time following engagement such that acceleration of the vehicle, and thus a jerking sensation upon engagement of the converter lock-up clutch, is reduced or prevented.

This application is a National Stage completion of PCT/EP2009/062591 filed Sep. 29, 2009, which claims priority from German patent application serial no. 10 2008 043 109.5 filed Oct. 23, 2008.

### FIELD OF THE INVENTION

The present invention relates to a method for engaging the converter lock-up clutch in a power-shift transmission of a working machine.

### BACKGROUND OF THE INVENTION

To reduce the power loss in a hydrodynamic torque converter, it is provided, according to the prior art, to use a converter lock-up clutch in power-shift transmissions, by way of which the turbine of the converter can be connected to the impeller. When the converter lock-up clutch is engaged, a loss-free drive connection thereby results between the drive engine and the transmission of the vehicle.

In applications known so far involving working machines such as dump trucks, graders, and crane vehicles, the converter lock-up clutch is engaged and disengaged depending on the rotational speed of the turbine, with consideration for the converter characteristic curve. In that particular case, a disengaged converter lock-up clutch is actuated for engagement when the rotational speed of the turbine exceeds a threshold value at which the same level of turbine torque is present when the converter lock-up clutch is engaged and when the converter lock-up clutch is disengaged. According to the prior art, an engaged converter lock-up clutch is actuated for disengagement when the rotational speed of the turbine falls below a threshold value at which the same level of turbine torque is present when the converter lock-up clutch is engaged and when the converter lock-up clutch is disengaged. These switching points are determined on the basis of the difference in the speed of rotation between the turbine and the impeller.

Due to this mode of operation, the vehicle is accelerated in the lower gears when the converter lock-up clutch engages in the partial load range due to an increase in engine torque caused by the reduction of engine speed that occurs during engagement, and this vehicle acceleration is typically perceived by the driver as unpleasant shift shock.

Document DE 37 12 498 C2 makes known a method for the integral control of an engine and an automatic transmission, between which a torque converter is disposed, the torque converter comprising a lock-up clutch which can be engaged in at least one shift stage of the automatic transmission, wherein the engine torque is regulated, during a shifting procedure, in order to suppress shift shocks.

In the known method, regulation of engine torque is initiated during upshifting, depending on the state of the lock-up clutch that is determined: if the lock-up clutch is in the disengaged state, regulation of engine torque is initiated when the currently detected engine speed falls below the previously detected engine speed, and, if the lock-up clutch is in the engaged state, regulation of engine torque is initiated when the currently detected engine speed falls below a value obtained by multiplying the rotational speed of the output shaft by the transmission ratio of the previously selected shift stage of the automatic transmission.

### SUMMARY OF THE INVENTION

The problem addressed by the present invention is that of providing a method for engaging the converter lock-up clutch in a power-shift transmission of a working machine, the implementation of which improves the quality of the engagement of the converter lock-up clutch, in particular in the partial load range. Furthermore, the acceleration and thus the jerking sensation, that occurs when the converter lock-up clutch is engaged, should be greatly reduced or prevented.

### DETAILED DESCRIPTION OF THE PREFERRED EMBODIMENTS

According thereto, a method for engaging the converter lock-up clutch is provided, wherein the engagement of the converter lock-up clutch is influenced by engine control, during the engagement process, by reducing the increase in engine torque, i.e., the gradient of the engine torque.

For this purpose, the available engine torque or turbine torque is determined, prior to an engagement of the converter lock-up clutch, and, depending on the engine torque or turbine torque that was determined, the gradient of the engine torque is controlled by way of the transmission control unit during engagement and, optionally, for a defined period of time following the engagement such that acceleration of the vehicle, and thus a jerking sensation during engagement, is reduced or prevented.

In that case, engine torque is ascertained by the engine control unit and transmitted via the CAN (Controller Area Network), to the transmission control unit; the turbine torque is determined by reference to the converter characteristic graph stored in the transmission control unit.

Preferably the gradient of the engine torque is controlled during the engagement, depending on the engine torque or turbine torque that was available prior to the engagement of the converter lock-up clutch by reference to a first characteristic curve stored in the transmission control unit.

According to a development of the invention, the gradient of the engine torque can also be controlled, for a defined period of time after the converter lock-up clutch is engaged, and this preferably occurs by reference to a second characteristic curve stored in the transmission control unit. It can be provided that torque is controlled in a ramped manner such that it matches the torque corresponding to the position of the accelerator pedal.

Furthermore, it can be provided that the second characteristic curve matches the first characteristic curve, and, after the engagement, the first characteristic curve is used to control the gradient of the engine torque.

The concept, according to the invention, makes it possible to reduce or prevent the increase in engine torque during engagement of the converter lock-up clutch, in particular during partial load engagement, thereby reducing the jerking sensation that occurs during engagement.

1-5. (canceled)

6. A method of actuating a converter lock-up clutch in a power-shift transmission of a working machine, the method comprising the steps of:
determining at least one of an engine torque and a turbine torque;
determining an increase in engine torque, by reference to a stored first characteristic curve, depending on the at least one of the engine torque and the turbine torque that was determined prior to the engagement of the converter lock-up clutch;
engaging the converter lock-up clutch; and
reducing the increase in the engine torque, during engagement of the converter lock-up clutch, by reference to the determined increase so as to minimize acceleration of the vehicle and thus minimizing a jerking sensation upon engagement of the converter lock-up clutch.

7. The method of actuating the converter lock-up clutch according to claim 6, further comprising the steps of ascertaining the engine torque, via an engine control unit,
transmitting the ascertained engine torque, via a control area network (CAN), to a transmission control unit, and
determining the turbine torque by reference to a converter characteristic graph stored in the transmission control unit.

8. The method of actuating the converter lock-up clutch according to claim 6, further comprising the step of storing the first characteristic curve in a transmission control unit.

9. The method of actuating the converter lock-up clutch according to claim 7, further comprising the step of storing the first characteristic curve in the transmission control unit.

10. The method of actuating the converter lock-up clutch according to claim 6, further comprising the step of, in a case in which a gradient of the engine torque is controlled by a transmission control unit for a defined period of time after engagement, this occurs with reference to a second characteristic curve stored in the transmission control unit.

11. The method of actuating the converter lock-up clutch according to claim 7, further comprising the step of, in the case in which a gradient of the engine torque is controlled by the transmission control unit for a defined period of time after engagement, this occurs with reference to a second characteristic curve stored in the transmission control unit.

12. The method of actuating the converter lock-up clutch according to claim 6, further comprising the step of controlling the engine torque in a ramped manner such that the engine torque matches torque corresponding to a position of the accelerator pedal.

13. The method of actuating the converter lock-up clutch according to claim 7, further comprising the step of controlling the engine torque in a ramped manner such that the engine torque matches torque corresponding to a position of the accelerator pedal.

14. A method of actuating a converter lock-up clutch in a power-shift transmission of a working machine, the method comprising the steps of:
determining at least one of an engine torque and a turbine torque;
determining an increase in engine torque, by reference to a stored first characteristic curve stored in a transmission control unit, depending on the at least one of the engine torque and the turbine torque that was determined prior to the engagement of the converter lock-up clutch;
engaging the converter lock-up clutch;
reducing the increase in the engine torque, during engagement of the converter lock-up clutch, by reference to the determined increase so as to minimize acceleration of the vehicle and thus minimizing a jerking sensation upon engagement of the converter lock-up clutch;
ascertaining the engine torque, via an engine control unit,
transmitting the ascertained engine torque, via a control area network (CAN), to a transmission control unit, and
determining the turbine torque by reference to a converter characteristic graph stored in the transmission control unit.

15. The method of actuating the converter lock-up clutch according to claim 14, further comprising the step of, in a case in which a gradient of the engine torque is controlled by a transmission control unit for a defined period of time after engagement, this occurs with reference to a second characteristic curve stored in the transmission control unit.

16. The method of actuating the converter lock-up clutch according to claim 15, further comprising the step of controlling the engine torque in a ramped manner such that the engine torque matches torque corresponding to a position of the accelerator pedal.
